(19) United States
(12) Patent Application Publication
(10) Pub. No.: US 2018/0094570 A1
(43) Pub. Date: Apr. 5, 2018

(54) Piston with Flame Guiding Passageways

(71) Applicant: Caterpillar Inc., Peoria, IL (US)

(72) Inventors: Kenth Svensson, Peoria, IL (US); Chad Palmer Koci, Washington, IL (US)

(73) Assignee: Caterpillar Inc., Peoria, IL (US)

(21) Appl. No.: 15/286,312

(22) Filed: Oct. 5, 2016

(51) Int. Cl. F02B 23/08; F02F 3/24

(52) U.S. Cl. CPC F02B 23/08; F02F 3/24

(57) ABSTRACT

An internal combustion engine may have a piston and a plurality of flame guiding passageways provided within the piston. The passageways may be configured within a circumferential wall of the piston to guide the one or more flames away from a stagnation point and to a mixing zone.

### TECHNICAL FIELD

The present disclosure generally relates to internal combustion engines and, more particularly, relates to pistons for internal combustion engines.

### BACKGROUND

Internal combustion engines typically contain one or more pistons. The pistons reciprocate up and down in corresponding and complementarily shaped cylinders present within the internal combustion engines. Such engines are often Otto cycle engines which employ a spark plug or the like for ignition, or Diesel cycle engines which rely on compression ignition. After ignition, (wherein the ignition may occur prior to the top dead center (TDC)) the piston descends within the cylinder in a power stroke before ascending for exhaust and then back down for intake in a repeating sequence.

The pistons of such engines typically include a cylindrical base that has a bottom portion connected to a crank shaft by a connecting rod or the like, and a top portion or piston crown opposite the bottom portion. The piston crown cooperates with the cylinder head to define a combustion chamber. It is within the combustion chamber that the air and fuel are mixed and ignited.

The piston crown is typically bowl-shaped and defined by a circumferential wall that extends from the cylindrical base of the piston. The circumferential wall of the piston may also be known as the piston bowl wall. A fuel injector is typically mounted in the cylinder head and extended into the combustion chamber to communicate fuel to the combustion chamber prior to ignition. Upon ignition, the resulting flame jets flow radially outward and impinge against the piston bowl wall. When the flames collide with the piston bowl wall, a stagnation point is created around the point where jet flames hit the piston bowl wall. Such stagnation points cause the momentum of the jet flames to be reduced.

A problem associated with such phenomena is that the lost momentum of the jet flames detrimentally affects mixing of air and fuel within the piston bowl. In other words, the jet flames within the piston bowl that lose momentum are also not able to reach a region of the piston bowl with a level of oxygen that would allow for a beneficial mixing of air and fuel within the piston bowl. Consequently, a significant amount of unused fuel or slow burning fuel may be present in piston bowls with stagnation points as the jet flames will continuously lose momentum as a result of the collisions. The jet flames will also continuously lose the opportunity to travel to a region of the piston bowl with a higher oxygen level, thereby not allowing for beneficial mixing of air and fuel, and ultimately making for a less efficient, more pollutant forming, engine.

Various engine configurations exist to purportedly improve fuel and air mixing prior to and during combustion. However, such configurations face the common challenge that the piston bowl wall is a fixed structure which continuously obstructs the jet flames and creates stagnation points. In one example, U.S. Pat. No. 4,898,135, discloses an internal combustion engine provided with a reaction chamber within its piston bowl wall to generate radical fuel species during combustion for use during a next succeeding combustion cycle. However, such a system does not have the capacity of allowing the jet flames to avoid collisions with the piston bowl walls. As a result, such systems do not reduce momentum loss of the jet flames within each piston and such systems create stagnation points relative to the piston bowl wall.

In view of the foregoing disadvantages associated with known pistons of internal combustion engines, a need exits for a cost effective solution which would not drastically alter the physical structure of the piston, and yet still allow jet flames travelling within the piston to preserve their momentum. In addition, a need exits for the jet flames to not only preserve their momentum while travelling within the piston bowl, but also be able to travel to an area of the piston bowl with a greater oxygen level to allow for a more beneficial mixing of air and fuel and thus less formation of soot and other pollutants. A still further need also exits for the jet flame to avoid contact with other jet flames. The present disclosure is directed at addressing one or more of the deficiencies and disadvantages set forth above. However, it should be appreciated that the solution of any particular problem is not a limitation on the scope of the disclosure or of the attached claims except to the extent expressly noted.

### SUMMARY OF THE DISCLOSURE

In one aspect of the present disclosure, an internal combustion engine is provided. The internal combustion engine may include an engine block having a plurality of cylinders therein, a piston reciprocatingly mounted in each cylinder and defining a combustion chamber, with the fuel being ignited in the combustion chamber and generating a plurality of flames. The internal combustion engine may also include a fuel injector communicating fuel to the combustion chamber and a piston crown extending from each piston and defining a piston bowl. The piston bowl has a plurality of stagnation points and mixing zones. The engine also includes a plurality of passageways in the piston crown to guide flames away from stagnation points and to mixing zones.

In another aspect of the present disclosure, a piston is provided. The piston may include a cylindrical base, a circumferential wall extending from the cylindrical base, a piston bowl defined by the cylindrical base and circumferential wall, and a passageway in the circumferential wall adapted to receive a flame and communicate the flame back to the piston bowl wherein the passageway guides the flame to a region with a higher oxygen level.

In yet another aspect of the present disclosure, a method of operating an internal combustion engine is provided. The method may include providing a piston within a cylinder with the piston having a crown with a plurality of flame guiding passageways therein. The piston crown defines a piston bowl and the method may also include injecting fuel into the piston bowl and then igniting the fuel to generate a plurality of flames. The method may also include receiving the flames within each passageway and guiding the flames within the passageways to exit in the piston bowl between other flames travelling within the piston bowl. Oxygen rich zones within the piston bowl may also be regions not configured between the flames.

These and other aspects and features will be more readily understood when reading the following detailed description in conjunction with the accompanying drawings.

### BRIEF DESCRIPTION OF THE DRAWINGS

FIG. 1 is a schematic, partially sectioned side view of an internal combustion engine in accordance with the present disclosure;

FIG. 2 is a sectional view of a representative piston and cylinder combination according to the present disclosure;

FIG. 3 is a perspective view of the piston of FIG. 2 in accordance with the present disclosure;

FIG. 4 is a top view of the piston of FIG. 3 depicting a plurality of jet flames;

FIG. 5 is a schematic top view of a piston with one exemplary jet flame and one flame guiding passageway in accordance with the present disclosure;

FIG. 6 is a sectional view of FIG. 5 taken along line 6-6 of FIG. 5; and

FIG. 7 is a flow chart depicting a sample sequence of steps in accordance with the present disclosure.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

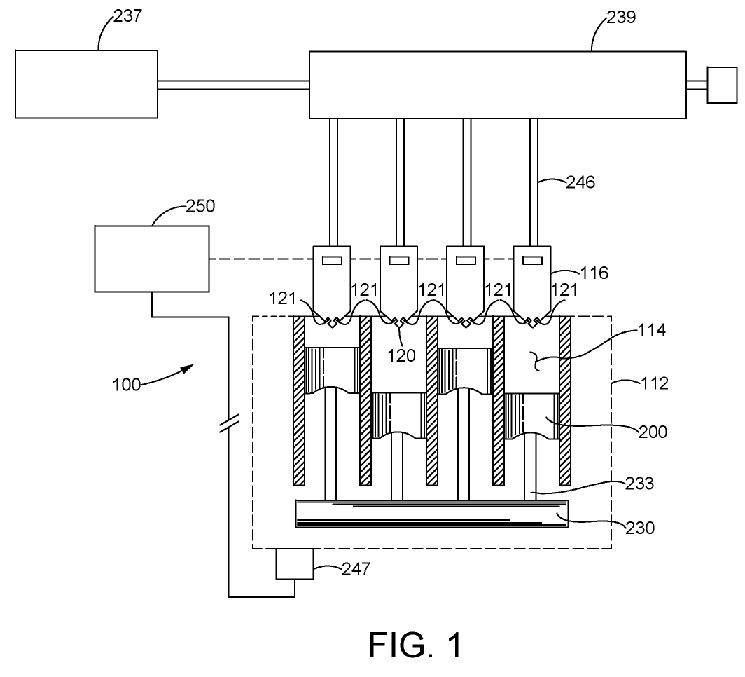

Referring now to the drawings and with specific reference to FIG. 1, an exemplary embodiment of an internal combustion engine 100 is depicted. With continued reference to FIG. 1, the internal combustion engine 100 is shown to include an engine block 112 with a plurality of cylinders 114 formed therein. Fuel injectors 116 may be disposed at more than one location relative to the block 112. The fuel injectors 116 may extend partially into each of the cylinders 114 to direct liquid fuel or the like therein. The fuel injectors 116 may include a fuel injector tip 120 with a plurality of orifices 121 that direct fuel in a plurality of radial directions into the associated cylinders 114.

The internal combustion engine 100 also includes a plurality of pistons 200 reciprocating within the plurality of cylinders 114. Each of the pistons 200 is movable to, among other things, increase cylinder pressures to a pressure sufficient to cause ignition of fuel as is well known in Diesel engines. Each piston 200 is coupled to a crankshaft 230 via a connecting rod 233 to cause rotation of the crankshaft 230. The internal combustion engine 100 may also include a fuel source 237. The fuel source 237 may be connected with each of the fuel injectors 116 by a common rail 239 or the like and a plurality of supply passages 246. Other configurations are possible. The internal combustion engine 100 may also comprise one or more sensors 247 to sense values indicative of engine speed or engine load or the like. The internal combustion engine 100 may also include a controller 250 hereinafter referred to as an engine control module (ECM) 250.

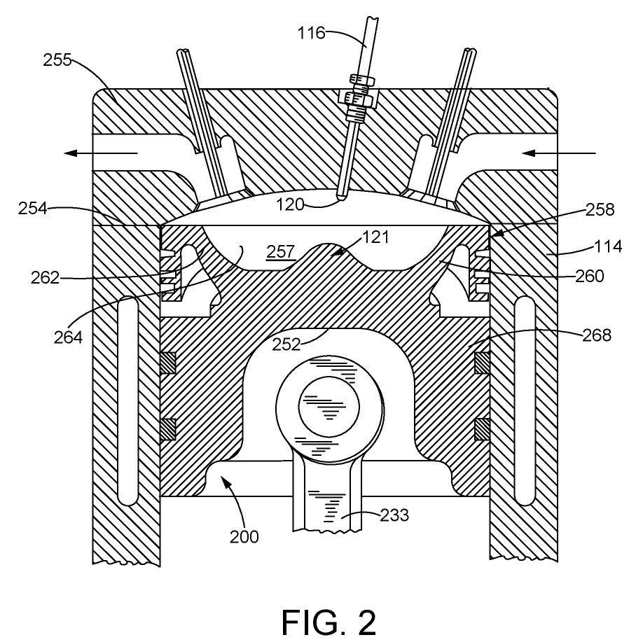

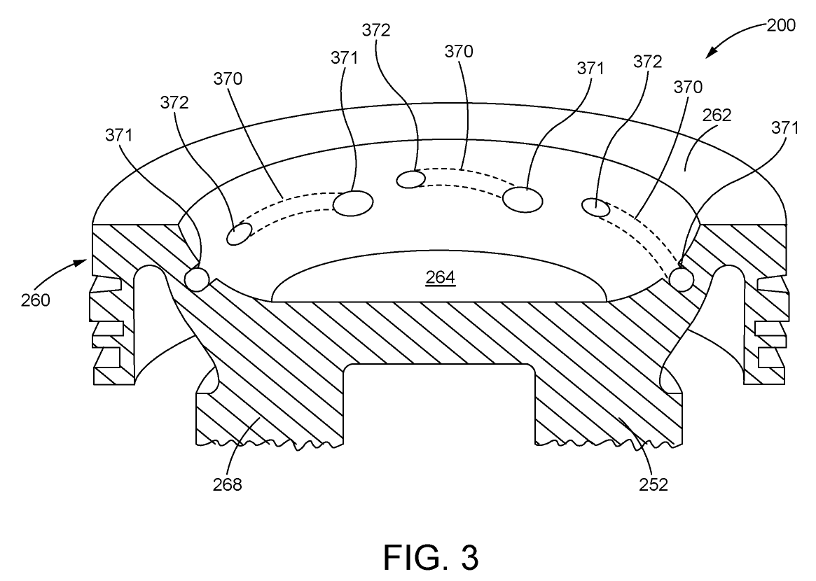

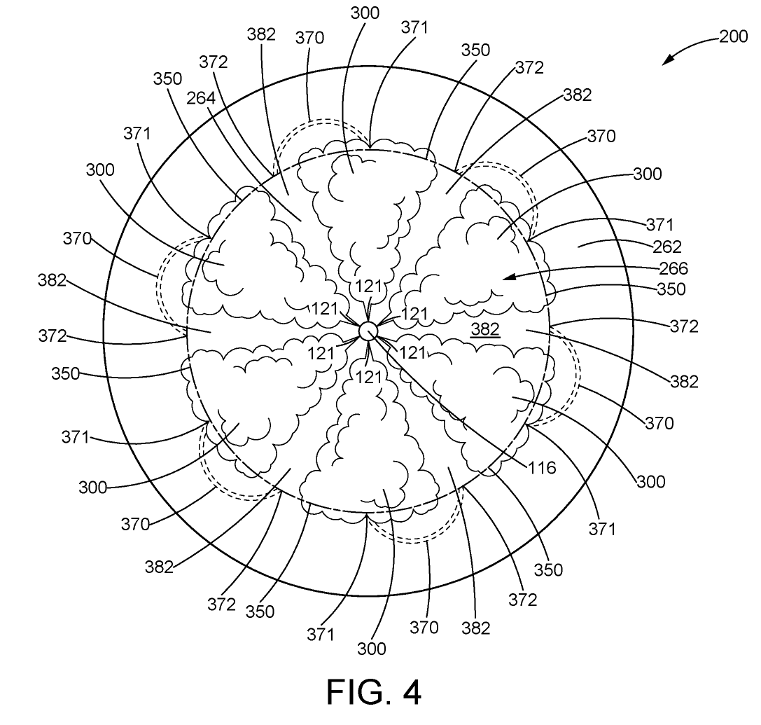

FIG. 2 illustrates a cross-section of one cylinder 114 and piston 200 combination in more detail. The piston 200 is shown connected to the connecting rod 233 at its bottom end 252. The cylinder 114 is closed at its top end 254 by a cylinder head 255 to define a combustion chamber 257 between an upper end 258 of the piston 200 and the cylinder head 255. The piston 200 may be topped with a piston crown 260 at its upper end 258. The piston crown 260 may include a circumferential wall 262 surrounding a bowl 264. The fuel injector 116 may be arranged to discharge fuel in a radially outward spray pattern 266 into the bowl 264 (see FIG. 4). As will be noted best from FIG. 3, the piston 200 also includes a cylindrical base 268 from which the piston crown 260 upwardly extends and defines the piston bowl 264. FIG. 3 also illustrates the bottom end 252, the piston crown 260, circumferential wall 262, piston bowl 264, flame guiding passageway 370, an ingress 371 and an egress 372.

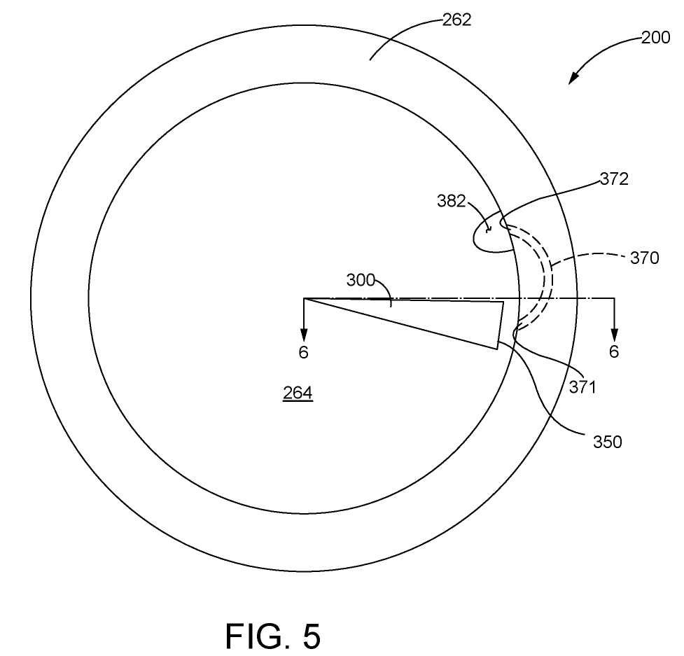

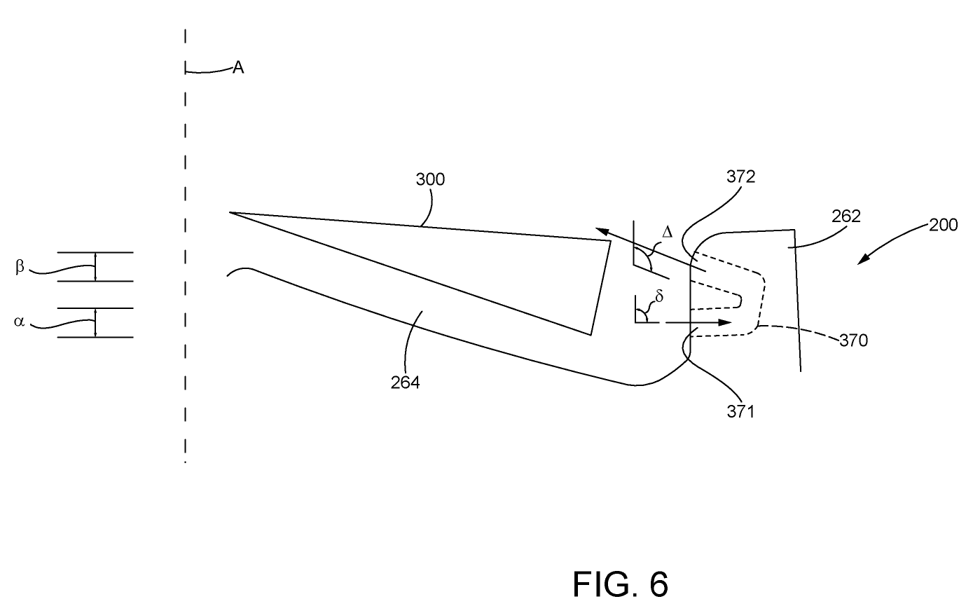

In operation, when fuel is injected and ignited, a plurality of distinct jet flames 300 extend radially outward from each injection orifice 121 toward the circumferential wall 262 as shown in the top view of FIG. 4. Six jet flames 300 are illustrated, however, it is to be understood that the present disclosure is not limited to necessarily injecting only six jet flames 300 as more or less may be provided. In any event, the jet flames 300 are shown expanding as they move radially outward and eventually coming into contact with the circumferential wall 262 of the piston crown 260. But for the provisions of the present disclosure, such collisions between the jet flames 300 and the circumferential wall 262 would create stagnation points 350 where the jet flames 300 lose their momentum on their trajectory within the piston bowl 264. However, the present disclosure improves upon the prior art in this regard by providing one or more flame guiding passageways 370 to allow the jet flames 300 to both preserve their momentum while travelling within the piston bowl 264 and enable communication of the jet flames 300 away from stagnation points 350 and to mixing zones 382 between adjacent flames 300 for improved mixing and combustion. The mixing zones 382 may also be configured in regions not between the jet flames 300 within the piston bowl 264. This process will be explained in further detail with respect to FIGS. 5 and 6.

Turning to FIG. 5, a schematic view of the piston 200 and piston bowl 264 with only one jet flame 300 is illustrated for better understanding. As explained above, a plurality of jet flames 300 may travel radially outward within the piston bowl 264 at any given time. However, in FIG. 5, only one jet flame 300 is illustrated to better explain how jet flames 300 may be routed away from stagnation point 350.

To be clear, however, each piston bowl 264 for each piston 200 may contain more than one stagnation point 350 as there will likely be more than one jet flame 300 travelling within the piston bowl 264 and each jet flame 300 creates its own stagnation point 350 when colliding with the circumferential wall 262. In addition, the entire jet flame 300 travelling within the piston bowl 264 may not generate one of the stagnation points 350. However, whether complete or partial, when the jet flame 300 collides with the circumferential wall 262, a stagnation point 350 is created and the jet flame 300 is less likely to travel to a region within the piston 200 that may have a greater level of oxygen. Further, the collision between the portion or entire jet flame 300 and the circumferential wall 262 causes momentum loss, whereas the inclusion of the flame guiding passageways 370 reduces momentum loss relative to not having the flame-guiding passageways 370.

To allow one or more of the jet flames 300 to preserve their momentum and travel to a region of the piston 200 with greater oxygen, the circumferential wall 262 of the present disclosure is configured with the one or more flame-guiding passageways 370. In doing so, a route away from the stagnation point 350 is provided for at least a portion of each jet flame 300. Further, each piston bowl 264 may contain a number of passageways 370 corresponding to the number of jet flames 300 to thereby enable each jet flame 300 to travel away from each potential stagnation point 350 with reduced momentum loss. More specifically, any portion of the jet flame 300 which enters the passageway 370 without collision maintains its momentum. After the jet flame 300 enters the passageway 370, the passageway 370 guides the jet flame 300 in a path away from the stagnation point 350. A curved path is illustrated in FIG. 6, however, any shaped path which allows the jet flame 300 to travel continuously within the passageway 370 away from stagnation point 350 may be utilized. The passageway 370 may also have a variety of cross-sectional shapes and a varying cross-sectional area to provide a path to allow the jet flame 300 to travel away from the stagnation point 350.

In the depicted embodiment, when the jet flame 300 has entered the passageway 370, the jet flame may complete a 180° turn away from the stagnation point 350 within the passageway 370. However, the jet flame 300 is not limited to completing a 180° turn within the passageway 370. For example, the jet flame 300 may undergo a variety of angular turns and a number of paths while within the passageway 370. Accordingly, the jet flame 300 is not limited to completing a turn at specific angles while travelling within the passageway 370. Importantly, by avoiding contact with the circumferential wall 262, a portion of the jet flame 300 does not suffer a loss of momentum and thus improves mixing and efficient engine operation.

Referring still to FIG. 5, after the jet flame 300 has completed its turn within the passageway 370, the jet flame 300 may then exit the passageway 370. The jet flame 300 may exit the passageway 370 between two or more other jet flames 300 that may also be travelling within the piston bowl 264. In the illustrated example above, each piston 200 may have six jet flames 300 travelling within the piston bowl 264 with six resulting mixing zones 382 being provided therebetween. By providing the passageways 370 to redirect the flames 300 away from stagnation points 350 and into mixing zones 382, the jet flame 300 arrives at a portion of the piston bowl 264 with a greater oxygen level. More specifically, the mixing zones 382 have a greater oxygen level than stagnation points 350. With the greater oxygen level in the mixing zones 382, there may be a greater mixing of oxygen and fuel. Accordingly, a beneficial result of the jet flame 300 entering and exiting the passageway 370 may be a greater mixing of oxygen and fuel within the piston bowl 264 and thus more efficient and complete combustion, with less soot emissions.

Turning now to FIG. 6, the jet flame 300 entering and exiting the passageway 370 is illustrated in side view. For convenience, a single jet flame 300 is again illustrated exiting the passageway 370, but more than one jet flame 300 and more than one stagnation point 350 may be present in each piston 200 as mentioned above. As also described above, after entering at ingress 371 the jet flame 300 completes its turn within the passageway 370, and then the jet flame 300 exits the passageway 370 at egress 372 into the mixing zone 382 between or proximate other jet flames 300. In addition, from the side view depicted in FIG. 6 it can be appreciated that the heights at which the flame 300 is first received by the passageways 370 (height α) and then communicated back to mixing zones 382 (height β) may be different. This also helps improve mixing. More specifically, the degree of interaction between the adjacent jet flames 300 is reduced as a result. In other words, the jet flames 300 which exit the passageways 370 have a lesser probability of coming into contact with the other jet flames 300 travelling within the piston 200 since they may re-enter at both a different radial position, and a different height. It will also be noted that the angle (δ) at which the jet flame 300 enters the passageway 270 relative to the longitudinal axis (Δ) may be different than the angle (Δ) at which the jet flame 300 exits the passageway 370.

In actual operation, multiple passageways 370 will likely be provided, and all jet flames 300 that, but for the present invention, may have completely collided with the circumferential wall 262 and generated stagnation points 350, now enter the passageways 370. While unlikely that an entire portion of the jet flames 300 enter the flame-guiding passageways 370, the jet flames 300 thus maintain a greater portion of their momentum by avoiding contact with the circumferential wall 262. Upon exiting the passageways 370 with preserved momentum, they enter mixing zones 382 having greater oxygen levels. As mentioned above, the greater oxygen levels therein enable for a greater mixing of air and fuel and thus more and complete combustion, with less soot emissions.

### INDUSTRIAL APPLICABILITY

In general, the present disclosure may find applicability in various industrial applications such as but not limited to internal combustion engines such as Diesel and Otto cycle engine. Such engines may be employed as prime movers, earth movers, rail, marine, and power generation equipment or the like to improve combustion efficiency. The present disclosure does so by improving mixing of air and fuel, and preserving the momentum of jet flames 300 moving through the piston bowl 264. The present disclosure also enables the jet flames 300 to avoid collisions with the circumferential wall 262 and with other jet flames 300. More specifically, the present disclosure provides passageways 370 within pistons 200 that allow the momentum of a plurality of jet flames 300 travelling therethrough to be largely preserved and to travel to mixing zones 382 of the piston 200 with greater oxygen levels. This avoids unnecessary contact with other jet flames 300 within the piston 200 which may have lost more momentum as a result of colliding with the circumferential wall 262 and creating one or more stagnation points 350 within the piston 200. By using passageways 370 within the circumferential wall 262 of the piston 200, the present application provides a simplified and cost effective means of allowing for greater mixing of air and fuel within a piston 200 without compromising the structure of the piston 200.

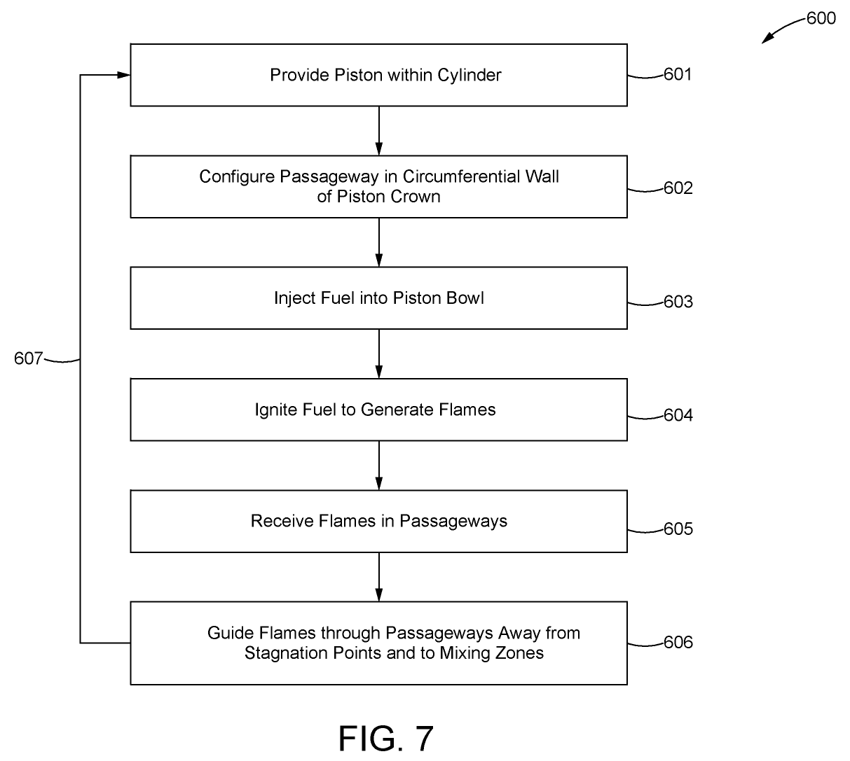

Turning now to FIG. 7, an exemplary method 600 for operating an internal combustion engine in accordance with the present disclosure is illustrated. Starting in block 601, the piston 200 is provided so as to reciprocate in the cylinder 114. The piston is itself further provided with a piston crown 260 having a circumferential wall 262 and piston bowl 264. In a next block 602, the passageways 370 are configured within the circumferential wall 262 of the piston 200. The passageway 370 may also be configured in a variety of shapes to best guide the jet flame 300 while avoiding contact with the circumferential wall 262 and creating stagnation points 350.

The method of FIG. 7 may also include a block 603 wherein fuel is injected into the piston bowl 264 and then ignited in a block 604. In a block 605, the passageway 370 receives the resulting jet flame 300 and then guides the flame through the circumferential wall 262 away from the stagnation point 350 and into a mixing zone 382. While within the passageway 370, the jet flame 300 may complete a 180° turn within the passageway 370. However, as mentioned above, the jet flame 300 is not limited to a 180° turn within the passageway 370. In addition, the passageway 370 may be configured in more than one shape, and the passageway 370 may also direct the jet flame 300 at more than one angle to continue in its trajectory away from the stagnation point 350. Accordingly, the passageway 370 may be configured in a variety of shapes to guide the jet flame 300 in a variety of angles in its trajectory.

Block 606 also exits the jet flames 300 into mixing zones 382 of the piston bowl 264 with a greater oxygen level than the stagnation point 350. Accordingly, the jet flame 300 entering into the mixing zone 382 with a greater oxygen level allows for an increased mixing of air and fuel as a result. The operation of the engine 100 thus is more efficient and produces less soot and other pollutants as well.

The method of FIG. 7 may also be configured to concurrently perform and repeat the process described above in blocks 601-606 with respect to the other jet flames 300 travelling within the piston bowl 264 as shown by block 607.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

1. An internal combustion engine, comprising:
an engine block having a plurality of cylinders therein;
a piston reciprocatingly mounted within each cylinder and defining a combustion chamber therebetween;
a fuel injector communicating fuel to the combustion chamber, the fuel creating a plurality of flames when ignited;
a piston crown extending from each piston and defining a piston bowl, the bowl having a plurality of stagnation points and a plurality of mixing zones; and
a plurality of passageways configured within the piston crown and adapted to guide flames away from the stagnation points and to the mixing zones.

2. The internal combustion engine of claim 1, wherein each passageway within the piston crown is configured to follow a curved path.

3. The internal combustion engine of claim 2, wherein each passageway completes approximately a 180 degree turn.

4. The internal combustion engine of claim 1, wherein each passageway within the piston crown has an entry point at one height and an exit point at a different height.

5. The internal combustion engine of claim 3, wherein each stagnation point is positioned radially inward from the piston crown.

6. The internal combustion engine of claim 1, wherein each of the mixing zones has a greater oxygen level than each of the stagnation points.

7. The internal combustion engine of claim 1, wherein each passageway extends within the piston crown a distance less than the circumference of the piston crown.

8. A piston, comprising:
a cylindrical base;
a circumferential wall extending from the cylindrical base;
a piston bowl defined by the cylindrical base and the circumferential wall; and
a passageway within the circumferential wall adapted to receive a flame from the piston bowl and communicate the flame back to the piston bowl, wherein the passageway guides the at least one flame to a region with a higher oxygen level.

9. The internal combustion system of claim 8, wherein the circumferential wall is a top crown of the piston.

10. The internal combustion system of claim 8, wherein the piston includes a plurality of passageways in the circumferential wall.

11. The internal combustion system of claim 8, wherein the passageway extends within the circumferential wall a distance less than the circumference of the circumferential wall.

12. The internal combustion system of claim 8, wherein the passageway is configured to receive the flame at one height and exit the passageway at a different height.

13. The internal combustion system of claim 8, wherein the passageway completes approximately a 180° turn within the circumferential wall.

14. The internal combustion system of claim 8, wherein the passageway entry and exit points receive and exhaust flames respectively at different angles relative to a longitudinal axis of the piston.

15. A method for operating an internal combustion engine, the method comprising:
providing a piston within a cylinder, the piston having a piston crown with a plurality of flame guiding passageways therein, the piston crown defining a piston bowl;
injecting fuel into the piston bowl;
igniting the fuel and generating a plurality of flames;
receiving each flame into one of the plurality of flame guiding passageways; and
guiding the flame within each passageway to exit into the piston bowl between other flames travelling within the piston bowl.

16. The method of claim 15, wherein the flames exiting each passageway are guided to a region within the piston bowl with a greater oxygen level than a region which the flame travelled through before entering the passageway.

17. The method of claim 15, wherein the flames that exit the passageways do not collide with the other flames travelling within the piston.

18. The method of claim 15, wherein the flames exit the passageways at a same height at which they entered the passageways.

19. The method of claim 15, wherein the flames exit the passageways only after completing an approximately 180 degree turn within the passageways.

20. The method of claim 15, wherein the flames exit the passageways at an angle relative to the longitudinal axis of the piston that is different than the angle at which the flames enter the passageways.
